(19) United States
(12) Patent Application Publication
(10) Pub. No.: US 2004/0041084 A1
(43) Pub. Date: Mar. 4, 2004

(54) Digital windowing for photoelectric sensors

(75) Inventor: Richard M. Carlson, Harrisburg, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: Telco Industries A/S, Store Heddinge (DK)

(21) Appl. No.: 10/456,253

(22) Filed: Jun. 6, 2003

Related U.S. Application Data
(60) Provisional application No. 60/387,152, filed on Jun. 7, 2002.

(51) Int. Cl. G06M 7/00

(52) U.S. Cl. 250/221

(57) ABSTRACT

A photoelectric sensor utilizing upper and lower numerical limits to control the output of the sensor. The sensor includes a transmitter and receiver and generates an internal signal whose magnitude corresponds to the magnitude of light received at the receiver. A controller activates the output driver on the basis of whether the magnitude of the internal signal lies between the upper and lower numerical limits. A user may set the limits numerically using a graphical user interface, and the magnitude of the internal signal may be measured numerically via an analog-to-digital converter. Successive readings may be averaged to improve accuracy.

### CROSS-REFERENCE TO RELATED APPLICATION

This application is entitled to the benefit of, and claims priority to, provisional U.S. Patent application Serial No. 60/387,152 filed Jun. 7, 2002 and entitled “DIGITAL WINDOWING FOR PHOTOELECTRIC SENSORS,” the entirety of which is hereby incorporated by reference.

### BACKGROUND OF THE PRESENT INVENTION

1. Field of the Present Invention

The present invention relates generally to photoelectric sensors, and, in particular, to methods and apparatuses for controlling the output signal of a photoelectric sensor on the basis of upper and lower numerical limits provided by a user.

2. Background

Photoelectric sensors are used to detect objects that affect light beams by either interrupting the beam or by reflecting the beam back to its source. Each photoelectric sensor includes a transmitter for generating the beam and a receiver for receiving or sensing the beam. Early photoelectric sensors used visible incandescent light sources as transmitters. However, most transmitters today are modulated infrared LED sources.

LED photoelectric transmitters use solid-state light emitting diodes (LED's) as light sources. LED's exhibit all of the long-life characteristics of other solid-state electronics. This life is unaffected by shock or vibration. By using a pulse-modulated signal, the sensors respond only to the light emitted by their own matched transmitter. This eliminates interferences from ambient light, including sunlight. Invisible infrared wavelengths (as from a TV remote control) are usually used, which has good penetration through dirt and dust. LED's are very small and require little operating power. They can be designed into very compact photoelectric packages.

Incandescent photoelectric transmitters are used when LED light will not work. Some applications require the use of visible incandescent light, and a wide variety of thru-beam sensors using incandescent transmitters are available. Although sold and specified in matched pairs (transmitter/receiver), any sensing head can be actuated by any light source that provides enough light. Sensors use either cad cells or, for greater sensitivity and higher temperature operation, phototransistors.

Regardless of what light-source is used, photoelectric sensors can operate as thrubeam, retro reflective or diffuse proximity devices. The light from a thru-beam transmitter (sometimes referred to as “through-beam”) is aimed directly at a separate receiver mounted opposite the transmitter along the same axis. Objects passing between the two units break the light beam. Because the light beam is focused, narrow, and not deliberately bounced off an object or a reflector, thru-beam detection generally has a greater sensing range than reflecting units (retro reflective or diffuse proximity) and greater freedom from false detection of shiny objects. Unless rigid-wave-guides are used, the separate transmitter and receiver must be carefully aligned during installation and kept in alignment during operation. This type of sensor allows for great sensing distances and is best for dusty, dirty, foggy and other harsh environments.

Diffuse proximity sensors, sometimes referred to as diffuse reflection sensors or optical proximity sensors, sense the presence of objects by bouncing light off of the object and detecting the diffuse reflected light. They can also be used for color detection and material-distinction if there is enough contrast. In diffuse proximity sensors, the transmitter, usually a wide beam source, and the receiver (or “selector”) are generally mounted in the same housing. This works best for large or nearby objects, and this type of sensor is generally the easiest to install. No alignment of multiple units is necessary, as for thru-beam, but it may be desirable to adjust the target so that it has a surface that is more perpendicular than a nearby background surface. The sensing range is very dependent on the reflectivity of the detected object, and diffuse proximity is best suited to situations where the object or material to be detected is brighter (more reflective) or much closer than background objects. Such sensors are necessary when both sides of an object cannot be accessed in order to place a thru-beam source/sensor or retro reflective unit/reflector. For example, individual items in a row on a conveyor belt cannot be optically distinguished except from above.

A retro reflective sensor generally provides a surer, simpler and more positive detection in applications where a reflector can be used. Like diffuse proximity sensors, the transmitter and receiver are generally located in the same housing. The transmitter projects light through the control lens to a retro reflective surface, which reflects the light directly back to the control lens. This is similar to thru-beam but an ordinary reflector is used instead of a separate sensor. Reflective discs are more efficient reflectors than retro reflective tape. The reflective surface may be up to 15 degrees from perpendicular, and may even be vibrating. The gain of the receiver is set so that the receiver will not respond to light reflected off of the object breaking the light beam (sometimes referred to as “proxing”). If the object is shiny or glossy, it may be necessary to angle the light beam so that it does not strike the object at right angles. Polarizing the light beam may also help. This may be accomplished by equipping the transmitter and receiver with special polarizing filters. The beam-diameter is controlled by the diameter of the reflector and is not generally precise enough for detecting small objects.

Current sensors, using phototransistors, photodiodes, and the like, are activated when a received signal has surpassed a threshold value. The threshold value may be controlled by the user via some adjustment (typically a potentiometer or pushbutton). This threshold is typically a voltage comparator which when crossed will activate the output. Unfortunately, known sensors are incapable of doing signal analysis within the period that the sensor's output is activated, and are very imprecise. Although some sensors are known to have digital output displays for displaying information about the strength of the signal of interest, they do not provide the user with the capability of establishing threshold or maximum trigger levels by directly inputting numeric values.

Another significant drawback to known sensors is their susceptibility to irregular, temporary, or other variations in the magnitude of signals of interest because of their reliance on analog signal processing techniques. For example, although the average magnitude of an analog signal may be well below the threshold level necessary to trigger the sensor output, the magnitude of the signal may very temporarily exceed the threshold, causing the output to switch undesirably when noise, irregularities in the surface of the target object, and the like, are encountered. Avoiding this problem with analog signal processing techniques is difficult and prohibitively expensive. Thus, a need exists for a photoelectric sensor making use of a simple, inexpensive signal or data averaging technique.

Further, known sensors are generally not very effective in certain situations at recognizing the difference between objects that should be ignored and the target object. For example, known sensors are often ineffective at recognizing the difference between a shiny background, which typically generates a higher return signal, and a dark, irregularly shaped object.

One technique that may be used to provide more reliable detection of certain objects is referred to as “background suppression.” This is generally used with diffuse proximity sensors and allows targets to be detected at a set sensing distance regardless of target color or reflectivity. This is accomplished by utilizing triangulated optics to determine the position of the received light in addition to the amount of received light. Less reflective targets are reliably detected against shiny or more reflective backgrounds, and this sensing mode works better in dirty environments than standard diffuse proximity sensors. Unfortunately, background suppression sensors have a tight switching hysteresis, making them ideal for shorter-range, level control applications. The hysteresis becomes a particularly important consideration when the background and the object to be detected are very close together.

There are some instances where the user may try to use the shinier background as a type of reflector and look for a signal that “drops out” when the product passes into view of the sensor. This method can be very unreliable especially if there is the chance that the background is not consistent or could change over time.

### SUMMARY OF THE PRESENT INVENTION

Digital windowing allows the user to set an upper cutoff limit and a lower cutoff limit based on the received signal strength of the photoelectric sensor. The output of the sensor will be active only when the signal strength is within the user-defined limits. The digital window can be adjusted by the user to be as large or as small as needed to fit the particular application of the user. This technology allows for easy detection of very dark irregular shaped objects against or in close proximity to more reflective backgrounds. For example, an O-ring may be detected within a stainless fitting. When used with transmitting LED's within the visible spectrum, color and contrast applications can be accomplished at relatively long sensing ranges. Many applications previously only possible with vision systems can also be solved using this technology.

The present invention comprises a photoelectric sensor utilizing user-definable upper and lower numeric limits to control an output signal. Broadly defined, the present invention according to one aspect comprises a photoelectric sensor that includes a transmitter that generates a beam of light; a receiver that receives at least a portion of the beam of light and generates an internal signal whose magnitude corresponds to the magnitude of light received; an output driver; and a controller, interposed between the receiver and the output driver, that activates the output driver only when the magnitude of the internal signal is within a user-defined range.

In features of this aspect, the sensor includes an analog-to-digital converter, connected in series between the receiver and the controller, that converts the magnitude of the internal signal to a digital value; the sensor includes an amplifier, connected in series between the receiver and the analog-to-digital converter, that amplifies the internal signal prior to conversion of the internal signal by the analog-to-digital converter; the sensor includes a user interface that accepts data, representative of the upper and lower limits of the user-defined range, from a user; the user interface includes a graphical user interface; the graphical user interface displays information about the value of at least one of the upper and lower limits; the graphical user interface prompts the user to enter at least one of the upper and lower limits; and the sensor is a thru-beam photoelectric sensor, a diffuse proximity photoelectric sensor, or a retro-reflective photoelectric sensor.

In another aspect of the present invention, a method of operating a photoelectric sensor on the basis of trigger level input from a user includes accepting, from a user, a numeric value representative of a trigger level to be used by the sensor; storing data, representative of the trigger level, in the sensor; transmitting a beam of light from the sensor; receiving at least a portion of the beam of light at the sensor; generating, within the sensor, an internal signal whose magnitude is proportional to the magnitude of the received beam of light; numerically comparing the magnitude of the internal signal to the stored trigger level data; and controlling a sensor output signal on the basis of whether the magnitude of the internal signal is above or below the trigger level represented by the stored trigger level data.

In features of this aspect, the comparing step includes converting the magnitude of the internal signal to a numeric value and comparing the numeric value to the stored trigger level data; the comparing step includes the steps of periodically converting the magnitude of the internal signal to a numeric value, averaging a plurality of numeric values produced in the converting step to produce an average numeric value, and comparing the average numeric value of the internal signal to the stored trigger level data; the generating step includes generating an internal signal whose magnitude is directly proportional to the magnitude of the received beam of light; the numeric value accepted from the user is representative of a new trigger level, and the step of storing data representative of a trigger level includes replacing data representative of an existing trigger level with data representative of the new trigger level; the method further includes displaying, to the user, a numeric indication of the stored trigger level; the controlling step includes enabling the sensor output signal only if the magnitude of the internal signal is above the trigger level represented by the stored trigger level data; the controlling step includes enabling the sensor output signal only if the magnitude of the internal signal is below the trigger level represented by the stored trigger level data; the numeric value accepted from the user is a first numeric value representative of a first trigger level, and the method further includes accepting, from a user, a second numeric value representative of a second trigger level to be used by the sensor, storing data, representative of the second trigger level, in the sensor, and in addition to comparing the magnitude of the internal signal to the first stored trigger level data, numerically comparing the magnitude of the internal signal to the second stored trigger level; and the controlling step includes controlling the sensor output signal on the basis of whether the magnitude of the internal signal is between the first and second trigger levels represented by the first and second stored trigger level data, respectively.

In still another aspect of the present invention, a method of operating a photoelectric sensor includes preserving, in the sensor, first data representative of an upper signal magnitude limit and second data representative of a lower signal magnitude limit; transmitting a beam of light from the sensor; receiving at least a portion of the beam of light at the sensor; generating, within the sensor, an internal signal whose magnitude is proportional to the magnitude of the received beam of light; comparing the magnitude of the internal signal to the upper and lower signal magnitude limits represented by the first and second data; and controlling a sensor output signal on the basis of whether the magnitude of the internal signal is between the upper signal magnitude limit and the lower signal magnitude limit.

In features of this aspect, the upper signal magnitude limit is a first numeric value and the lower signal magnitude limit is a second numeric value; the comparing step includes numerically comparing the magnitude of the internal signal to the upper and lower signal magnitude limit data; the comparing step includes the steps of periodically converting the magnitude of the internal signal to a numeric value, averaging a plurality of numeric values produced in the converting step to produce an average numeric value, and comparing the average numeric value of the internal signal to the upper and lower signal magnitude limits represented by the first and second data; the generating step includes generating an internal signal whose magnitude is directly proportional to the magnitude of the received beam of light; and the method further includes, upon request by a user, displaying, to the user, a numeric indication of the upper and lower signal magnitude limits represented by the first and second data preserved in the sensor.

In yet another aspect of the present invention, a method of operating a photoelectric sensor includes preserving, in the sensor, data representative of a trigger level to be used by the sensor; transmitting a beam of light from the sensor; receiving at least a portion of the beam of light at the sensor; generating, within the sensor, an internal signal whose magnitude is proportional to the magnitude of the received beam of light; periodically converting the magnitude of the internal signal to a numeric value; averaging a plurality of numeric values produced in the converting step to produce an average numeric value; comparing the average numeric value of the internal signal to the trigger level represented by the preserved data; and controlling a sensor output signal on the basis of whether the average numeric value of the internal signal is above or below the trigger level.

In features of this aspect, the averaging step includes averaging a predetermined number of the numeric values most recently produced in the converting step; the method includes excluding, from each set of numeric values being averaged, the highest and lowest individual values prior to executing the averaging step; the generating step includes generating an internal signal whose magnitude is directly proportional to the magnitude of the received beam of light; the trigger level is a first trigger level, and the method includes preserving, in the sensor, data representative of a second trigger level to be used by the sensor and, in addition to comparing the average numeric value of the internal signal to the first trigger level, comparing the average numeric value of the internal signal to the second trigger level represented by the second preserved data; and the controlling step includes controlling the sensor output signal on the basis of whether the average numeric value of the internal signal is between the first and second trigger levels.

### BRIEF DESCRIPTION OF THE DRAWINGS

Further features, embodiments, and advantages of the present invention will become apparent from the following detailed description with reference to the drawings, wherein:

FIG. 1 is a perspective view of a photoelectric sensor in accordance with a first preferred embodiment of the present invention;

FIG. 2 is a block diagram of the internal hardware components of the sensor of FIG. 1;

FIG. 3 is a flowchart diagram illustrating steps taken by the sensor of FIG. 1 in conjunction with the sensor microcode in executing a digital window adjustment process;

FIG. 4 is a flowchart diagram illustrating steps taken by the sensor of FIG. 1 in conjunction with the sensor microcode in executing the digital windowing process;

FIG. 5 is a flowchart diagram illustrating steps taken by the sensor of FIG. 1 in conjunction with the sensor microcode in executing an enhanced version of the digital windowing process; and

FIG. 6 is a perspective view of a photoelectric sensor in accordance with a second preferred embodiment of the present invention.

### DETAILED DESCRIPTION OF THE PREFERRED EMBODIMENTS

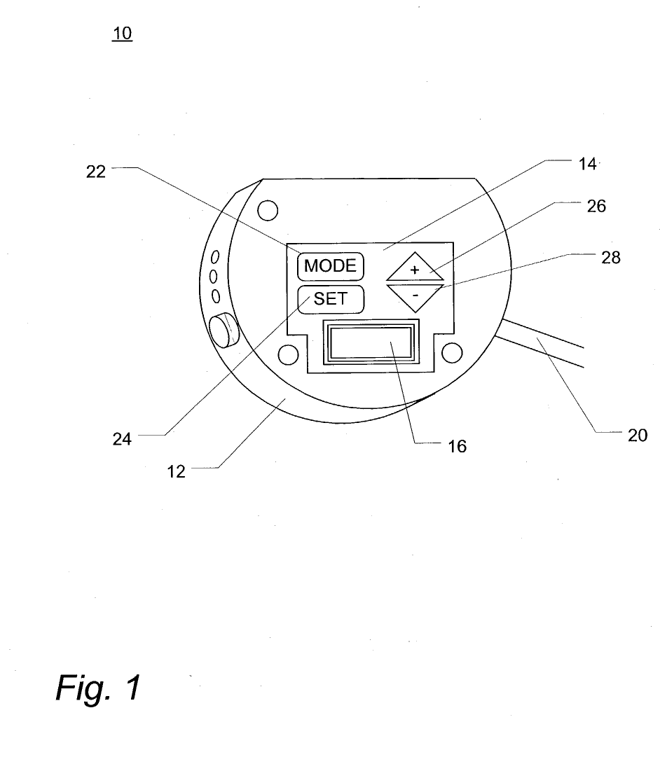

Referring now to the drawings, in which like numerals represent like components throughout the several views, the preferred embodiments of the present invention are next described. FIG. 1 is a perspective view of a photoelectric sensor 10 in accordance with a first preferred embodiment of the present invention. The sensor 10 of the present invention includes a housing 12, a keypad interface 14, a display 16, a set of visual operational indicators 18, a cable connection 20 and a collection of internal components. The housing 12 may be formed from ABS plastic. The keypad interface 14 may include a “MODE” key 22, a “SET” key 24, a “+” key 26 and a “−” key 28. The display 16 may be a liquid crystal display (“LCD”) unit with four digits. The visual indicators 18, each of which is preferably a light-emitting diode (“LED”), may include one LED to indicate that the sensor's power on is on, a second LED to indicate that the output of the sensor is active, and a third output to indicate gain reserve. The cable connection 20 includes the power supply for the sensor 10, the sensor output line, and any other inputs and outputs that may be necessary or useful for the sensor's operation.

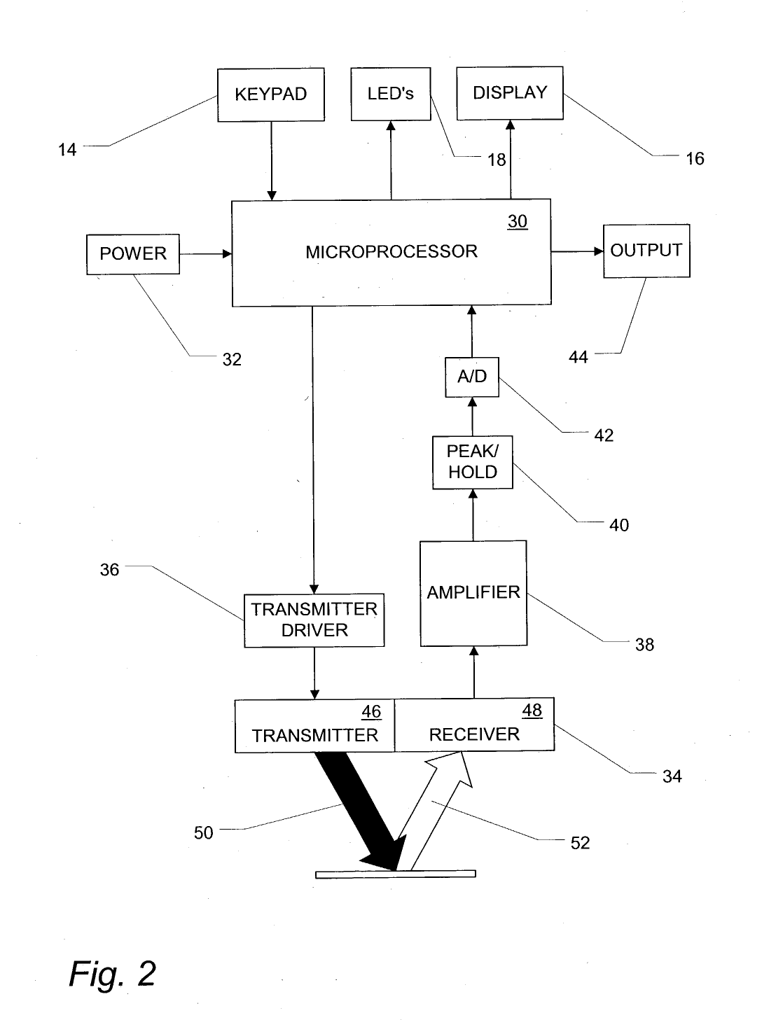

Each sensor 10 includes both hardware and software components. FIG. 2 is a block diagram of the internal hardware components of the sensor 10 of FIG. 1. The internal components of the sensor 10 include a microprocessor 30, a power conditioning circuit 32, a transmitter and receiver assembly 34, a transmitter driver 36, an amplifier 38, a peak hold circuit 40, an analog-to-digital (“A/D”) converter 42 and an output driver 44. The microprocessor 30, which controls the operation of the sensor 10, includes connections to the keypad interface 14, the display 16, the LED's 18, the power conditioning circuit 32 and the output driver 44. Power is supplied to the microprocessor 30 and other components of the sensor 10 through the cable connection 20 from an external power source and conditioned via the power conditioning circuit 32. The microprocessor 30 also includes an interface with the transmitter driver 36, which in turn triggers operation of the transmitter and receiver assembly 34.

The transmitter and receiver assembly 34 includes a transmitter 46 for generating a light beam and a receiver 48 for sensing light. The light may be visible or non-visible and may or may not be in laser form. The placement of the transmitter 46 relative to the receiver 48 depends, in part, upon the type of sensor 10. In retro-reflective and diffuse proximity sensors, the transmitter 46 and receiver 48 are typically housed together. For example, the sensor type illustrated schematically in FIG. 2 is of the retro-reflective type. On the other hand, in thru-beam sensors, the transmitter 46 and receiver 48 are often housed separately, because the light beam 50 produced by the transmitter 46 must be received directly by the receiver 48. Regardless of the placement of the receiver 48 relative to the transmitter 46, the receiver 48 also preferably includes a bandpass filter for limiting the range of light gathered by the receiver 48.

The output of the receiver 48 is connected to the amplifier 38 and from there to the peak hold circuit 40. Preferably, means is provided for adjusting the sensitivity of the amplifier 38. This may he accomplished via either a direct potentiometer control 19, as shown in FIG. 1, or via software means, as described below. The output of the peak hold circuit 40 is connected to the input of the A/D converter 42, which is preferably a 10-bit converter, and from there to the microprocessor 30. Based on the data ultimately received from the receiver 48 via this path, the microprocessor 30 may cause an output signal to be generated at the output driver 44 and transmitted externally via the cable connection 20.

The operation of the microprocessor 30 and the peripheral components is controlled by the software components of the sensor 10. The software is preferably in the form of microcode, which may be stored in the program memory of the microprocessor 30.

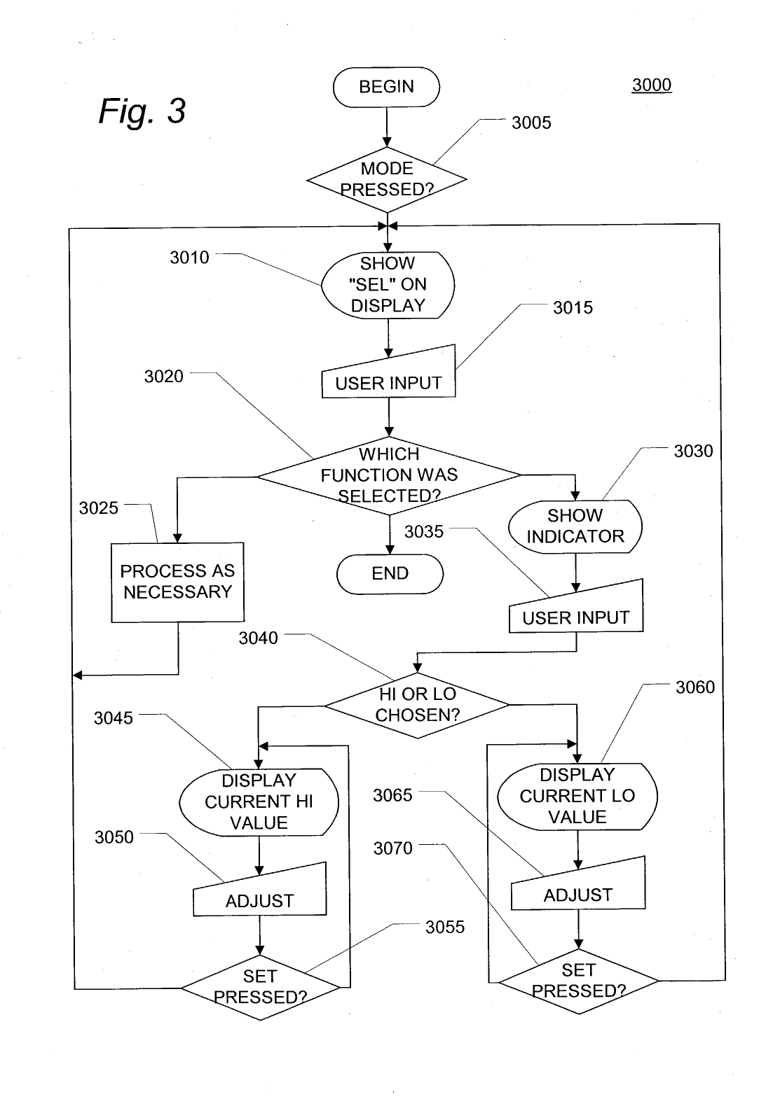

To set the digital window, a user may use the keypad interface 14. FIG. 3 is a flowchart diagram illustrating steps taken by the sensor 10 of FIG. 1 in conjunction with the sensor microcode in executing a digital window adjustment process 3000. In the illustrated embodiment, the user may edit the digital window settings by pressing the “MODE”key 22, as shown at step 3005, thus causing the device to enter an “edit” mode. When the sensor 10 is in edit mode, a predetermined message or indicator, such as the letters “SEL,” is generated on the display 16 at step 3010. Next, at step 3015, the user may choose to edit any editable parameter, or may choose to exit the “edit” mode. Editable parameters may include a variety of parameters in addition to the digital window settings. For example, the user may choose to increase or decrease the sensitivity of the amplifier 38 (if no dedicated potentiometer control 19 is provided) or to select automatic sensitivity adjustment; adjust the output mode between “normally open” and “normally closed;” and edit various time delays, such as the “on” time delay, the “off” time delay, and the “one shot” time delay.

In an embodiment preferred for its simplicity, the user may, at step 3015, use the “+” and “−” keys 26, 28, or a combination thereof, to select a parameter for editing, or may press the “SET” key 24 to exit the “edit” mode. If, at step 3020, it is determined that one of these other editable parameters is chosen, then the desired parameter may be adjusted at step 3020 through the use of the “+” and “−” keys 26, 28, or a combination thereof, and the desired parameter value may be stored by pressing the “SET” key 24. Further, if at step 3020 the microprocessor 30 determines that the “SET” key 24 has been pressed, then the microprocessor 30 exits the “edit” mode and returns to normal processing.

On the other hand, if at step 3020 it is determined that that the user has chosen to adjust the digital windowing parameters, then as shown at step 3030, an appropriate message or indicator may be displayed to the user. At step 3035, the user may choose whether to adjust the upper limit or the lower limit of the digital window by pressing the “+” key 26 or “−” key 28, respectively. If at step 3040 it is determined that the “+” key 26 has been pressed, then the current value of the upper limit may appear on the display 16 at step 3045. If the upper limit has not previously been adjusted, then the current value may be a default value, which in a preferred embodiment is 1000. The user may then adjust the value at step 3050 using the “+” and “−” keys 26, 28, or a combination thereof. When the desired value has been reached, the value may be stored at step 3055 by pressing the “SET” key 24. Similarly, if at step 3040 it is determined that the “−” key 28 has been pressed, then the current value of the lower limit may appear on the display 16 at step 3060. If the lower limit has not previously been adjusted, then the current value may be a default value, which in a preferred embodiment is 30. The user may then adjust the value at step 3065 using the “+” and “−” keys 26, 28, or a combination thereof. When the desired value has been reached, the value may be stored by pressing the “SET” key 24 at step 3070, causing the microprocessor 30 to return to step 3010 to permit other parameters to be edited.

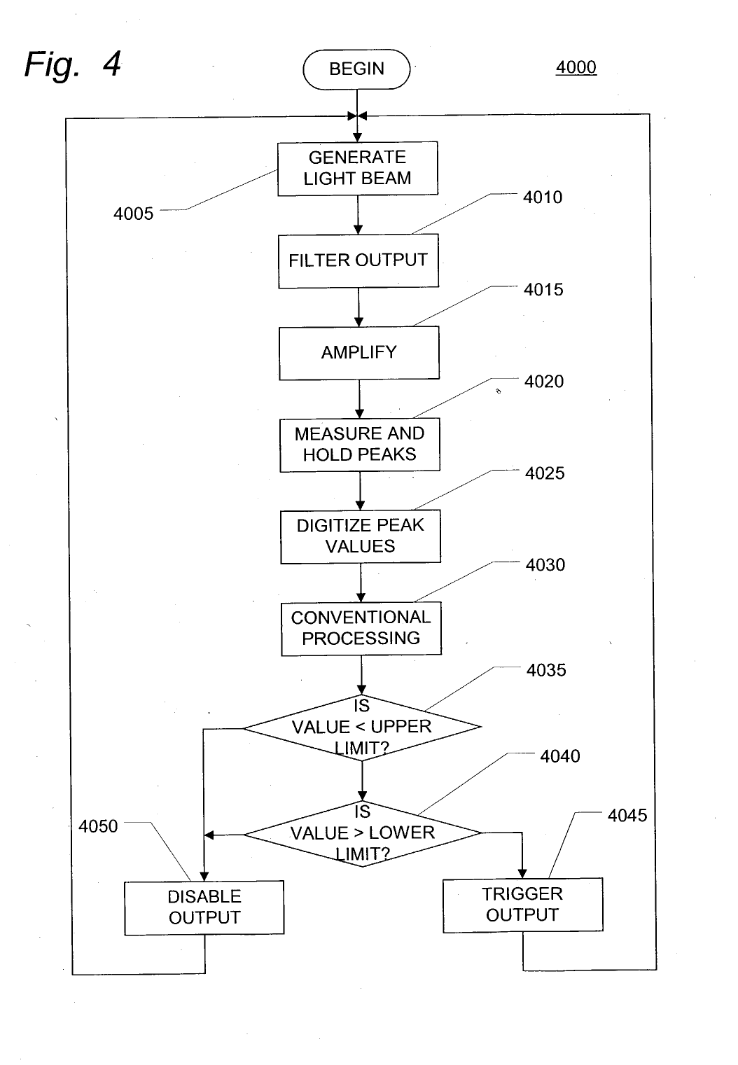

FIG. 4 is a flowchart diagram illustrating steps taken by the sensor 10 of FIG. 1 in conjunction with the sensor microcode in executing the digital windowing process 4000. Under control of the microprocessor 30, the transmitter driver 36 at step 4005 causes the transmitter 46 to generate a beam of light 50 of known characteristics. Although the receiver 48 may need to be positioned differently, relative to the transmitter 46, depending upon whether the sensor 10 is of the thru-beam, retro reflective or diffuse proximity type, the overall operation of the sensor 10 is the same. At step 4010, the resultant light 52 received at the receiver 48 is filtered by the bandpass filter, and at step 4015 is amplified by the amplifier 38, where the amount of gain of the amplifier 38 may be controlled by the user either via the direct potentiometer control 19 or via the microprocessor 30. The resulting signal may be loaded into the peak/hold circuit 40 at step 4020, and the analog voltage present on the peak/hold circuit 40 may be periodically converted into a digital value at step 4025 by the A/D converter 42 for processing by the microprocessor 30.

As each digitized value is received by the microprocessor 30, the value may be analyzed to determine what the resulting output generated by the output driver 44 should be. In addition to any other conventional processing carried out by the microprocessor 30 at step 4030, the digital windowing feature permits the microprocessor 30 to trigger the output driver 44 based upon whether the magnitude of the digitized value lies between the stored upper and lower limits of the digital window. Depending upon the sensor's application, the microprocessor 30 may be programmed to trigger the output driver 44 any time a digitized reading lies within the digital window, or it may be programmed to trigger the output driver 44 any time a digitized reading falls outside the digital window. Thus, when a digitized value is received, it is compared to the upper limit of the digital window and to the lower limit of the digital window at steps 4035 and 4040, respectively. If the sensor 10 is used to signal the occurrence of a reading within a predetermined range, then assuming any other mandatory conditions are met, the output driver 44 is triggered at step 4045 when the digitized value is more than the minimum value and less than the maximum value. Processing then returns to step 4005, wherein the controlled light beam is generated. On the other hand, if the digitized value is less than the minimum value or more than the maximum value, then the output driver 44 is disabled at step 4050 before processing returns to step 4005 to generate a controlled beam of light 50 once again.

The sensor 10 may alternatively be used to signal the occurrence of a reading outside a predetermined range. Although not illustrated, the output of the sensor 10 would be the logical inverse of that shown in FIG. 4. In other words, the output driver 44 is triggered when the digitized value is less than the minimum value or more than the maximum value. It should be apparent that this variation may be easily accomplished without departing from the scope of the present invention.

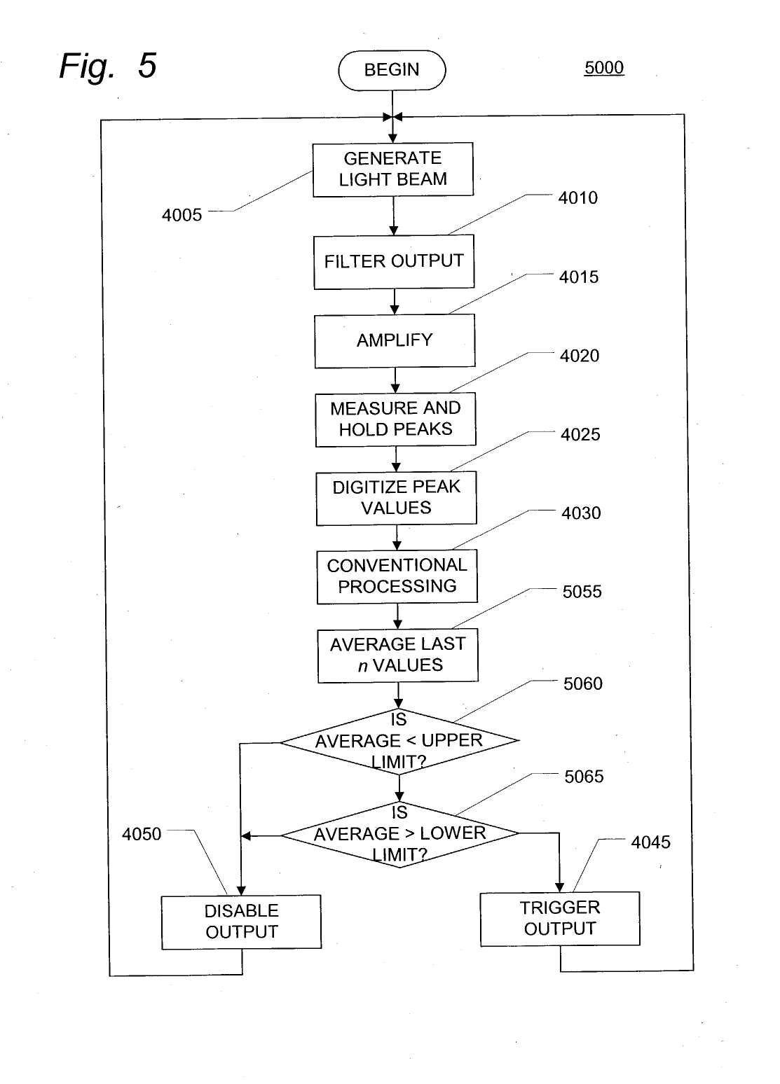

FIG. 5 is a flowchart diagram illustrating steps taken by the sensor 10 of FIG. 1 in conjunction with the sensor microcode in executing an enhanced version of the digital windowing process 5000. As with the process 4000 illustrated in FIG. 4, a beam of light 50 is generated at step 4005, and the resultant light 52 received at the receiver is filtered at step 4010 and amplified at step 4015. The resulting signal may be loaded into the peak/hold circuit 40 at step 4020, and the analog voltage present there may be periodically converted into a digital value at step 4025. Unlike the process 4000 of FIG. 4, however, an extra step is carried out in conjunction with any conventional processing carried out by the microprocessor 30 at step 4030. More particularly, at step 5055, the most recent digitized value is averaged with a predetermined number of sequential digitized values. The averaged value is then compared to the upper limit of the digital window and to the lower limit of the digital window at steps 5060 and 5065, respectively. The output driver 44 is then either triggered or disabled accordingly at steps 4045 and 4050, respectively.

By using averaged values, rather than individual values, operation of the sensor 10 may be insulated from noise and other irregularities in the magnitude of the signal, and reliability may thus be improved. In a preferred embodiment, the last five digitized values are averaged, but it should be apparent that larger or smaller numbers of values may be alternatively be used. Further, for still greater reliability, the highest and lowest values in the group of values may be ignored, thus ensuring that the average values are not skewed improperly by the presence of a single extremely high or low value in the set of values.

As with other sensors, the output signal that is actually generated by the output driver 44 may be dependent upon a number of factors, including the selected output type (e.g., normally open or normally closed), any time delays programmed by the user, and any other parameters that may be programmed by the user or inherent in the design of the sensor 10.

Often, in order to determine suitable values for the upper and lower limits of the digital window, it may be necessary to first determine a typical range of measured values for a target. To do this, the target is first placed within the sensing field of the sensor 10. The chosen target is preferably of the type that is to be operated on by the sensor 10, and the target is positioned such that the desired detection point on the target is within the path of the sensor's light beam 50. With the target in place, the transmitter driver 36 causes the transmitter 46 to generate the light beam 50. The resultant light 52 received at the receiver 48 is filtered and amplified by the amplifier 38, and the resulting signal is loaded into the peak/hold circuit 40. After being converted into a digital value by the A/D converter 42, the resulting digitized value may be presented to the user via the display 16. With this information, the user may then select appropriate values for the upper and lower limits of the digital window. If desired, the user may repeat this process numerous times in order to more precisely determine a suitable range, identify outlier values, and the like. Once the upper and lower limits are finally determined, the chosen values may be input into the sensor 10 using the process illustrated in FIG. 3.

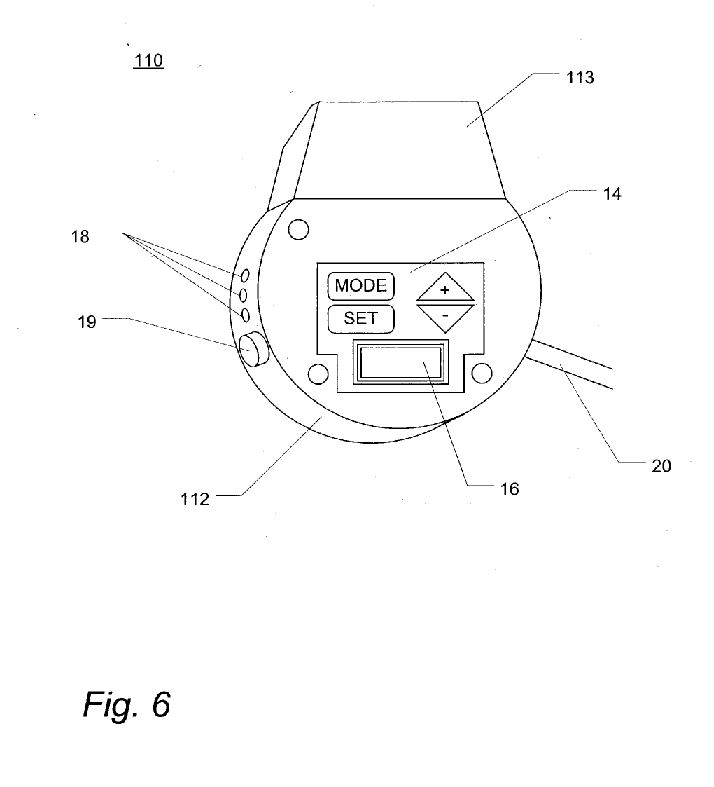

FIG. 6 is a perspective view of a photoelectric sensor 110 in accordance with a second preferred embodiment of the present invention. This embodiment may be useful for applications in which limited clearance is available. Like the sensor 10 of the first preferred embodiment, the sensor 110 of the second preferred embodiment includes a housing 112, a keypad interface 14, a display 16, a set of visual operational indicators 18, a cable connection 20 and a collection of internal components, and may include a direct potentiometer control 19. The various internal and external components are generally similar to those of the sensor 10 of the first embodiment. However, the housing 112 of the second embodiment is modified relative to the housing 10 of the first embodiment. The modified housing 112, which may be formed from ABS plastic, includes an angle adapter portion 113 in which the transmitter and receiver assembly 34 is housed in such a way that the transmitter 46 and receiver 48 are oriented to generate and receive light beams at a right angle to the general orientation of the sensor 110. Because the sensing field is thus disposed at a different orientation, relative to the sensor 110, than that of the first embodiment of the sensor 10, it may be possible to employ the second embodiment of the sensor 110 in locations for which the first sensor embodiment may be ill-equipped. It should also be apparent that other transmitter/receiver orientations, other housing shapes, fiber optics, and other methods and variations may likewise be utilized without departing from the scope of the present invention.

The teachings of the present invention may be used with a wide variety of photoelectric sensor types, including thru-beam, retro-reflective and diffuse proximity sensors. In addition, the present invention may be used in conjunction with other, techniques used to enhance the operation of the various sensor types. These include the use of background suppression, particularly with diffuse proximity sensors; the use of polarization with retro-reflective sensors; and the use of fiber optics, with any type of sensor, to make remote sensor placement possible. Although applications for digital windowing may have yet to be developed for each of these various types of photoelectric sensors, it should be apparent that all uses of digital windowing with photoelectric sensors are considered to be within the scope of the present invention.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiments, it is to be understood that this disclosure is only illustrative and exemplary of the present invention and is made merely for purposes of providing a full and enabling disclosure of the invention. The foregoing disclosure is not intended, nor is it to be construed, to limit the present invention or otherwise to exclude any other embodiments, adaptations, variations, modifications and equivalent arrangements, the present invention being limited only by the claims appended hereto and the equivalents thereof.

What is claimed is:

1. A photoelectric sensor, comprising:
a transmitter that generates a beam of light;
a receiver that receives at least a portion of the beam of light and generates an internal signal whose magnitude corresponds to the magnitude of light received;
an output driver; and
a controller, interposed between the receiver and the output driver, that activates the output driver only when the magnitude of the internal signal is within a user-defined numerical range.

2. The sensor of claim 1, further comprising an analog-to-digital converter, connected in series between the receiver and the controller, that converts the magnitude of the internal signal to a digital value.

3. The sensor of claim 2, further comprising an amplifier, connected in series between the receiver and the analog-to-digital converter, that amplifies the internal signal prior to conversion of the internal signal by the analog-to-digital converter.

4. The sensor of claim 2, further comprising a user interface that accepts data, representative of the upper and lower limits of the user-defined numerical range, from a user.

5. The sensor of claim 4, wherein the user interface includes a graphical user interface.

6. The sensor of claim 5, wherein the graphical user interface displays information about the value of at least one of the upper and lower limits.

7. The sensor of claim 5, wherein the graphical user interface prompts the user to enter at least one of the upper and lower limits.

8. The sensor of claim 2, wherein the sensor is a thru-beam photoelectric sensor.

9. The sensor of claim 2, wherein the sensor is a diffuse proximity photoelectric sensor.

10. The sensor of claim 2, wherein the sensor is a retro-reflective photoelectric sensor.

11. A method of operating a photoelectric sensor on the basis of trigger level input from a user, the method comprising the steps of:
accepting, from a user, a numeric value representative of a trigger level to be used by the sensor;
storing data, representative of the trigger level, in the sensor;
transmitting a beam of light from the sensor;
receiving at least a portion of the beam of light at the sensor;
generating, within the sensor, an internal signal whose magnitude is proportional to the magnitude of the received beam of light;
numerically comparing the magnitude of the internal signal to the stored trigger level data; and
controlling a sensor output signal on the basis of whether the magnitude of the internal signal is above or below the trigger level represented by the stored trigger level data.

12. The method of claim 11, wherein the comparing step includes converting the magnitude of the internal signal to a numeric value and comparing the numeric value to the stored trigger level data.

13. The method of claim 12, wherein the comparing step includes the steps of:
periodically converting the magnitude of the internal signal to a numeric value;
averaging a plurality of numeric values produced in the converting step to produce an average numeric value; and
comparing the average numeric value of the internal signal to the stored trigger level data.

14. The method of claim 11, wherein the generating step includes generating an internal signal whose magnitude is directly proportional to the magnitude of the received beam of light.

15. The method of claim 11, wherein the numeric value accepted from the user is representative of a new trigger level, and wherein the step of storing data representative of a trigger level includes replacing data representative of an existing trigger level with data representative of the new trigger level.

16. The method of claim 11, further comprising the step of displaying, to the user, a numeric indication of the stored trigger level.

17. The method of claim 11, wherein the controlling step includes enabling the sensor output signal only if the magnitude of the internal signal is above the trigger level represented by the stored trigger level data.

18. The method of claim 11, wherein the controlling step includes enabling the sensor output signal only if the magnitude of the internal signal is below the trigger level represented by the stored trigger level data.

19. The method of claim 11, wherein the numeric value accepted from the user is a first numeric value representative of a first trigger level, the method further comprising the steps of:
accepting, from a user, a second numeric value representative of a second trigger level to be used by the sensor;
storing data, representative of the second trigger level, in the sensor; and
in addition to comparing the magnitude of the internal signal to the first stored trigger level data, numerically comparing the magnitude of the internal signal to the second stored trigger level.

20. The method of claim 19, wherein the controlling step includes controlling the sensor output signal on the basis of whether the magnitude of the internal signal is between the first and second trigger levels represented by the first and second stored trigger level data, respectively.

21. A method of operating a photoelectric sensor, the method comprising the steps of:
preserving, in the sensor, first data representative of an upper signal magnitude limit and second data representative of a lower signal magnitude limit;
transmitting a beam of light from the sensor;
receiving at least a portion of the beam of light at the sensor;
generating, within the sensor, an internal signal whose magnitude is proportional to the magnitude of the received beam of light;
comparing the magnitude of the internal signal to the upper and lower signal magnitude limits represented by the first and second data; and
controlling a sensor output signal on the basis of whether the magnitude of the internal signal is between the upper signal magnitude limit and the lower signal magnitude limit.

22. The method of claim 21, wherein the upper signal magnitude limit is a first numeric value and the lower signal magnitude limit is a second numeric value.

23. The method of claim 21, wherein the comparing step includes numerically comparing the magnitude of the internal signal to the upper and lower signal magnitude limit data.

24. The method of claim 23, wherein the comparing step includes the steps of:
periodically converting the magnitude of the internal signal to a numeric value;
averaging a plurality of numeric values produced in the converting step to produce an average numeric value; and
comparing the average numeric value of the internal signal to the upper and lower signal magnitude limits represented by the first and second data.

25. The method of claim 21, wherein the generating step includes generating an internal signal whose magnitude is directly proportional to the magnitude of the received beam of light.

26. The method of claim 21, further comprising the step of:
upon request by a user, displaying, to the user, a numeric indication of the upper and lower signal magnitude limits represented by the first and second data preserved in the sensor.

27. A method of operating a photoelectric sensor, the method comprising the steps of:
preserving, in the sensor, data representative of a trigger level to be used by the sensor;
transmitting a beam of light from the sensor;
receiving at least a portion of the beam of light at the sensor;
generating, within the sensor, an internal signal whose magnitude is proportional to the magnitude of the received beam of light;
periodically converting the magnitude of the internal signal to a numeric value;
averaging a plurality of numeric values produced in the converting step to produce an average numeric value;
comparing the average numeric value of the internal signal to the trigger level represented by the preserved data; and
controlling a sensor output signal on the basis of whether the average numeric value of the internal signal is above or below the trigger level.

28. The method of claim 27, wherein the averaging step includes averaging a predetermined number of the numeric values most recently produced in the converting step.

29. The method of claim 28, further comprising the step of excluding, from each set of numeric values being averaged, the highest and lowest individual values prior to executing the averaging step.

30. The method of claim 27, wherein the generating step includes generating an internal signal whose magnitude is directly proportional to the magnitude of the received beam of light.

31. The method of claim 27, wherein the trigger level is a first trigger level, the method further comprising the steps of:
preserving, in the sensor, data representative of a second trigger level to be used by the sensor; and
in addition to comparing the average numeric value of the internal signal to the first trigger level, comparing the average numeric value of the internal signal to the second trigger level represented by the second preserved data.

32. The method of claim 31, wherein the controlling step includes controlling the sensor output signal on the basis of whether the average numeric value of the internal signal is between the first and second trigger levels.
